(19) United States
(12) Patent Application Publication
(10) Pub. No.: US 2002/0130104 A1
(43) Pub. Date: Sep. 19, 2002

(54) Demetallizing in register with a pre-printed web

(76) Inventor: Daniel Lieberman, San Diego, CA (US)

Correspondence Address: BROWN, MARTIN, HALLER & MCCLAIN LLP, 1660 UNION STREET, SAN DIEGO, CA, 92101-2926, US

(21) Appl. No.: 09/809,141

(22) Filed: Mar. 15, 2001

(51) Int. Cl. B44C 1/22; C03C 15/00; C03C 25/68

(52) U.S. Cl. 216/35

(57) ABSTRACT

A method is described wherein a pre-printed film or paper web is selectively demetallized in register with the images pre-printed on the web. This provides the ability to demetallize micro-text, photographs or pictures, or demetallize a pattern (wallpaper) over an already demetallized area, or demetallize in patterns to create moiré patterns for security applications and/or for enhancing the attractiveness of internal and external packaging.

### BACKGROUND OF THE INVENTION

1. Field of the Invention

This invention relates to processes of demetallizing metallized film or paper webs.

2. Background of the Invention

Known processes of demetallization of metallized webs can have numerous applications, one of which is to control the heat conductivity in microwave oven packaging. A limitation of such processes is that they do not include preprinted images or embossing and therefore do not relate to registration to images on the web.

There are known methods for demetallizing films including removal of the metal by use of caustic solutions or electrical current.

There is a method known and described in U.S. Pat. No. 4,959,120 (Wilson) wherein a metallized film is selectively demetallized in different areas resulting in a film with graduated optical density from one area to another. This method describes how, through the demetallization process, the amount of metal removed is achieved by exposing different parts of the metallized film to an etchant. The etchant is applied in the form of different sized minute drops on different portions of the metallized film so more of the metal is removed in some parts of the film than in others and so different parts of the metallized film show differences in optical density.

Another method for demetallization by use of electrical currents is described in U.S. Pat. No. 4,258,086 (Beall) where a pattern on one metallized surface is reproduced onto another metallized surface. This is done by placing the two surfaces close to each other and subjecting them to microwave energy for enough time to remove metal from the second metallized surface in accordance with the pattern found on the first metallized surface.

None of the known methods, however, provide for demetallization or removal of metal from substrates in register to a pre-printed web. In these previously known methods, the demetallization processes were based on simply removing the metal from webs without images upon them and therefore used no registration process. These prior processes also made no specific references to security applications or enhancing the aesthetics of packaging. Thus, there is a need for a process of demetallization of metallized materials that permits selective or partial removal of metal in register to the images pre-printed on the web.

### SUMMARY OF THE INVENTION

These limitations and problems of the prior art have been overcome by the present invention, which provides a new and improved process for demetallizing a metallized web containing images placed by printing or optical image formation. Placement may comprise embossing, casting or injection molding. Printing may comprise flexographic, offset, rotogravure, letter or other conventional printing methods. Optical image formation may comprise formation of holographic, optical variable device, diffractive, dot-matrix, computer-generated holographic or computer-generated optical images. For brevity herein the image-containing web or the placed images will sometimes be referred to as a “pre-printed” web or “pre-printed” images.

Metallized webs of film or paper are commonly used these days for security purposes, as in labels or seals, and for creating aesthetically pleasing, attractive external and internal packaging. A pre-printed web is a continuous roll of film or paper containing holographic, diffractive, optical variable devices, optically computer-generated holograms, holographic and diffractive dot-matrix images, or non-holographic images or patterns. Demetallization, using the method described in this invention, provides enhanced security for security type documents or labels where demetallized images or micro text can be disguised within or around the original image so as to be undetectable to the unaided eye and to prohibit duplication or re-use of the document. In addition, this process provides for demetallizing images or patterns within a metallized image, so as to produce designs that visually enhance the attractiveness of packaging.

This invention involves a process of demetallizing film or paper webs by a method for demetallizing selective areas on a web in register to pre-printed images on that web. The demetallization takes place on the web in order to ensure demetallization occurs precisely where it is desired on the web. This invention describes the process for selectively demetallizing in dots, dot-matrix dots, lines, or any other pattern in register to an original image. The dots or lines are registered in relation to the pre-printed web in such a way so that they form an image, pattern, micro text or moiré.

This invention also provides a method for restricting a hidden image to a specific location in a hologram, then demetallizing the entire hologram except for the area containing the hidden image, or demetallizing only within the hologram, and leaving the rest of the area around it metallized. Both of these methods must occur in register to the original hologram.

This invention also allows selective demetallization resulting in moiré patterns.

Finally, this invention describes how the demetallization process can be used on any type of film or paper and using most printing presses including flexographic presses, rotogravure, letterpress and offset printing presses and also by using the cold foil stamping method.

In a standard printing or embossing process, a metallized film or paper web passes through a standard printing or embossing station where images or patterns are pre-printed upon it. In this invention, after the metallized web has been pre-printed, it passes through a demetallizing station where the thin metal film attached to the web is selectively removed in the form of the image or pattern desired. This invention adds the registration process to ensure that the removal of the metal occurs exactly where it is desired in relation to the pre-printed images.

### BRIEF DESCRIPTION OF THE DRAWINGS

FIG. 1 is a schematic diagram illustrating the demetallization process on a standard printing press, including an inset showing in plan view a portion of the metallized web in detail.

FIG. 2 is a perspective view of a product produced by the process of the present invention.

FIG. 3 is an enlargement of the center circle area 3 in FIG. 2.

FIG. 4 is a schematic diagram illustrating the demetallization process of the present invention further using the cold foil stamping process on a printing press.

FIG. 5 is a graphical representation of a moiré pattern created by the demetallization process.

### DETAILED DESCRIPTION AND PREFERRED EMBODIMENTS

Metallized webs of film or paper are commonly used these days for security purposes, as in labels or seals, and for creating aesthetically pleasing, attractive external and internal packaging.

This invention relates to the process of demetallizing film or paper webs and describes a method for demetallizing selective areas on a web in register to the images on the web. A pre-printed web is a continuous roll of film or paper containing holographic, diffractive, optical variable images or patterns, optically computer-generated holograms, holographic or diffractive dot-matrix images or patterns, or non-holographic images or patterns. For example, a web containing holographic images goes through a registration process prior to demetallization. The registration process ensures that the removal of the metal occurs exactly where it is desired in relation to the pre-printed images. The process described in this invention has significant security applications as well as packaging enhancement applications.

This invention works in the following manner.

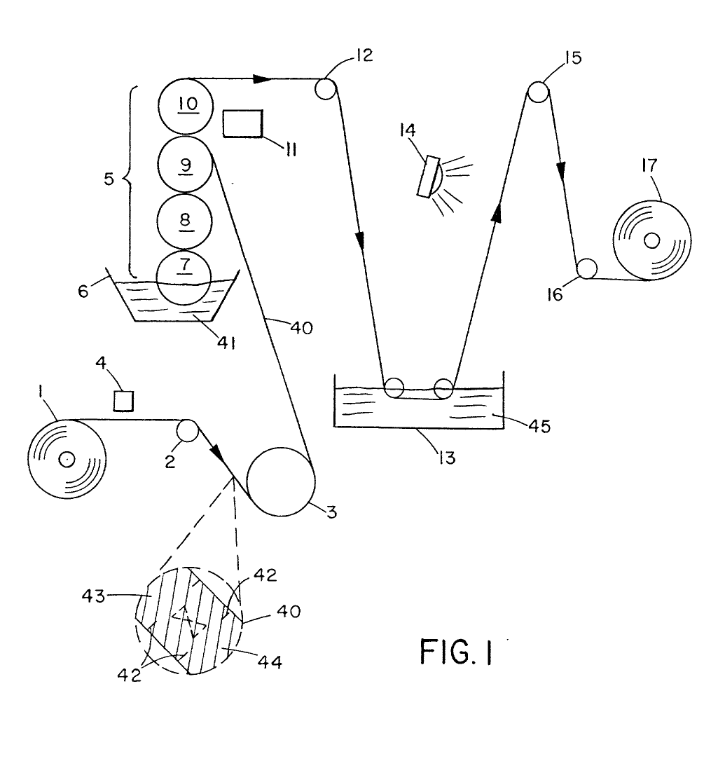

FIG. 1 illustrates the demetallization process on a standard printing press. An image-printed continuous film or paper web 40 which has been metallized on one side by metal layer 44 with registration marks 42 already printed next to one or more of images 43, (indicated as covered by the metal layer in the inset) is moved through the printing or embossing process where images or patterns are pre-printed upon it. If it is rewound into a roll after the printing or embossing, it must be unwound from a continuous roll 1 with the metallized side up. As the web 40 moves to the demetallization station 5 along the press rollers 2 and 3, the registration or eye marks 42 on the web material 40 are read by a registration sensor 4, for example a laser, fiber-optic or similar sensor, which relays the information as a signal to the demetallization station 5. At the demetallization station, the web 40 moves through a bank of press rollers 7, 8, 9 and 10. The speed at which the web 40 travels is determined by the registration information conveyed by the registration sensor 4 to the demetallization station 5 and is controlled by a servo motor 11 attached to the demetallization station. The application of the registration information is determined by a simple computer software program which causes the servo motor 11 to spin faster or slower depending upon the registration information. The servo motor 11 then adjusts the speed of the demetallization station roller 10 and thus the speed at which the web 40 travels in order to ensure that the demetallization occurs exactly where designed in relation to the original images. The demetallization station 5 consists of a printing station 6 as might normally deposit ink, but in this invention deposits a caustic substance or etchant 41, capable of removing metal from the web material 40. This chemical etchant 41, commonly sodium hydroxide (NaOH) in solution, is deposited onto the film 40 through the bank of rollers in relation to the pre-printed images 42 determined by the patterns on design/printing plates mounted on roll 9. The etchant 41 oxidizes the metal 44 to powder in the areas applied. The web 40 is then routed by roller 12 to a washing station 13 where the powder is removed. The web 40 then travels past a drying station 14 where a heat source, for example an infrared light, removes all water from the web surface. The web is then routed by rollers 15 and 16 to rewinding cylinder 17 where it is rewound into a roll.

The key aspect is the registration process. Without the “reading” of the registration marks 42 on the preprinted images 43, specific designs or images cannot be demetallized exactly where desired in relation to the original images.

It will be recognized that the degree and location of demetallization will vary according to the pattern on the face plates of the demetallization roller 10. The etchant 41 may at any point remove the entire local depth of the metal layer, or may merely thin it in a greater or lesser amount. The demetallization in any local area can result in one or more lines, dots or other shapes where the metal is removed or thinned, or an array of small adjacent regions of metal and metal removal, in patterns analogous to halftone printing with inks.

The demetallization process uses a standard printing press set up, with printing plates determining the demetallization design, and a standard inking station used to apply the etchant 41.

The addition of a registration set up, using a registration sensor 4 to read and relay the registration information to the demetallization station 5, is critical. The registration sensor 4 can be a fiber optic device, a laser or any similar type of device that senses the eye mark 42 on the web 40 and relays a signal to a motor 11 attached to a cylinder 10 that controls the speed at which the web 40 moves at a specified point and causes the roller 10 to spin faster or slower as required. The information and how it is applied is preferably written in a simple computer program. Fiber optic, laser, and other sensors or sensing devices are readily available from sensing device vendors, readily identified by publications such as the Thomas Register.

The washing station 13 for removal of the oxidized metal 44 also uses a standard inking station, in which the washing solution 45 is water.

The drying station 14 is standard equipment on flexographic presses for drying inks.

The applications provided by this invention include ensuring additional security for documents requiring means for authentication, and to enhance the aesthetics in all types of packaging. An example of a security application is a security label containing an image where the owner wants to ensure the product label cannot be counterfeited. A design or pattern is selected that can be “hidden” in the original image by demetallizing a selected area, image or part of an image that may not be detectable to the unaided eye. In the case of a holographic image, a section containing a hidden code, numbers, or micro text may be demetallized or the area around a code, number or micro text may be demetallized. An example of a packaging enhancement application might be to demetallize an image or pattern on a container, or preprinted label or the area around the image or pattern allowing the demetallized area to be transparent or opaque.

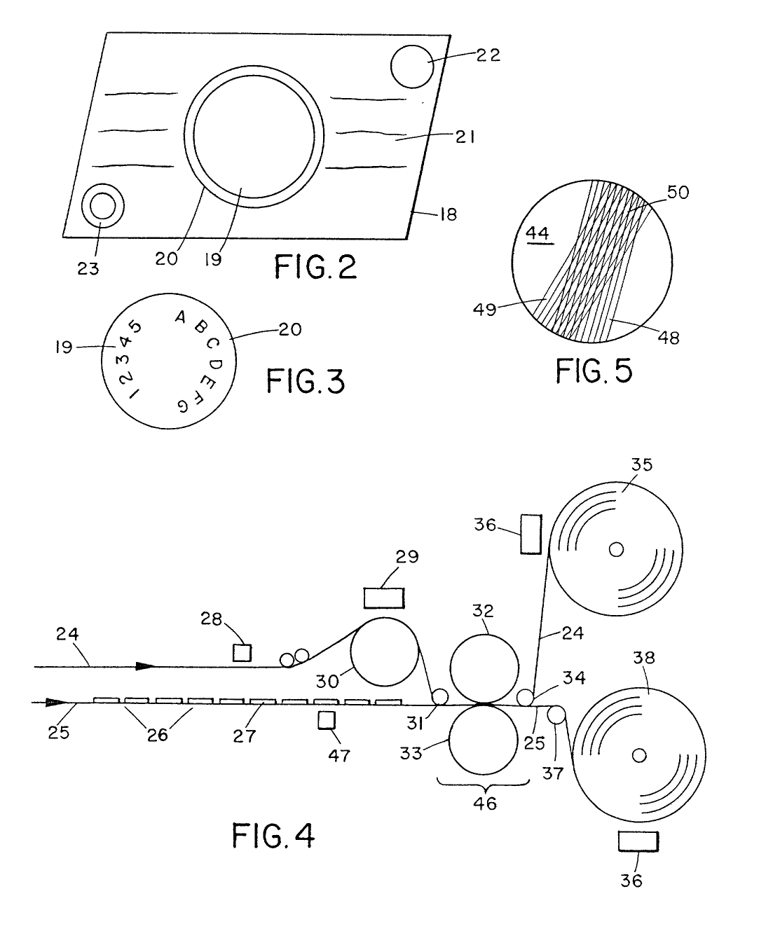

FIG. 2 illustrates applications for this demetallization process. When the pre-printed or pre-embossed metallized web 40 passes through the demetallizing station 5, the thin metal film 44 attached to the film or paper is selectively removed in the form of the image, part of an image, design or pattern desired, and in register with the original image. The caustic solution or etchant 41 at the demetallizing station 5 dissolves the metal in the pattern or image desired. For example, an already embossed web that contains holographic images can have a portion of an image within the hologram removed, or the area around a portion of the image removed using this process. The area to be demetallized must be registered to the original holographic or printed image, which can be done either just prior to or concurrently with the demetallization process. FIG. 2 shows a label with a metallized surface 18 containing a holographic image 19. An example of a demetallized image could be micro-text 20. The label could contain flexographic printing 21 on top of the metallized surface. Demetallization could result in a transparent demetallized area containing a metallized hidden image 22. Demetallization could also result in a metallized area containing a demetallized hidden image 23.

FIG. 3 shows a close-up view of a holographic image 19 where the demetallization has left micro text 20.

It is also contemplated that demetallizing in register to a pre-printed web can be integrated with a cold foil stamping process. FIG. 4 shows this system.

A cold foil web 24 has preprinted images and demetalization in discrete surface areas after exiting from the process of FIG. 1, and will have eye marks for registration with a substrate 25, such as a paper web, to which the image/demetallization areas (“patches”) are to be transferred. Discrete areas of adhesive 27 are applied to the substrate 25 at station 26. The adhesive areas also have corresponding eye marks for registration with the image/demetallization areas. The web 24 and substrate 25 are aligned facing each other by roller 31 at the entrance to station 46. A registration sensor 28 registers the image/demetallized area locations on web 24 by their eye marks and a similar sensor 47 registers the adhesive 27 pattern locations on substrate 25 by their eye marks. Both sensors relay their registration information to indexing means 29, such as a servo motor, attached to press roller 30 located just before the alignment nip 31, and the speed of foil web 24 is adjusted to insure registration with the substrate 25 through the marrying zone 46. In zone 46 the two webs 24 and 25 travel into the nip of press rollers 32 and 33 where the adhesive areas 27 are pressure joined to the undersurface of the foil web 24, each in registration with a corresponding image/demetallized area. As the two married webs pass the rollers 32 and 33 and reach the end of zone 46, they encounter separation roller 34. The foil web 24 is curved around roller 34 while the substrate 25 travels in a straight path, causing the image/adhesive patches to peel away from the foil 24 and remained adhered to the substrate 24. The stripped foil web 24 then is wound onto motor-36-driven takeup roller 35 where it is collected for reuse, discard, or other purpose. The substrate 25, now having on its surface the transferred patches, continues on over guide roller 37 to takeup roller 38 (also driven by a similar motor 36) for collection.

The demetallization process described by this invention can be used on any type of film or paper and uses standard printing presses including flexographic presses, rotogravure, letterpress and offset printing presses, and associated conventional equipment. These presses require the addition of at least one registration setup including registration sensors, and the modification of a standard inking station to perform the demetallization process. The equipment required to apply the method of this invention can be purchased from standard printing industry vendors, which also may be found in standard publications such as the Thomas Register.

This invention also allows selective demetallization resulting in moiré patterns, as illustrated in FIG. 5. As is well known, a moiré pattern 50 is created when two repetitive groups 48 and 49 of lines, circles or arrays of dots are superimposed upon one another, with imperfect alignment. The pattern of light and dark lines result in a moiré pattern. Moiré patterns are commonly used, for instance, to print currency or other security type documents to inhibit duplication of the document. This invention provides for the formation of moiré patterns such as 50 by having one of the groups (e.g., 48) preprinted and overlaid by the metal layer 44 so that when the second group (e.g., 49) is superimposed by demetallization, a moiré pattern is achieved that is extremely difficult to decode or to duplicate.

It will be evident that there are numerous embodiments of the present invention which are not expressly described above but which are clearly within the scope and spirit of the present invention. The above description is therefore intended to be exemplary only, and the actual scope of the invention is to be determined from the appended claims.

I claim:

1. A method for selective demetallization of a web material, comprising;
providing a web material having thereon an preplaced image and a registration mark and coated with a metal film;
conveying said web material to a demetallization station comprising a demetallization roll including indexing means for adjusting location of said demetallization roll;
prior to passage of said web material through said demetallization station, observing said registration mark with observation means and in response to such observation causing said indexing means to move said demetallization roll to align said demetallization roll to be in register with said web material; and
passing said web material through said demetallization station with said image in register with said demetallization roll;
whereby predetermined portions of said metal film are removed or thinned to create or reveal visual elements of said web material in registration with said image.

2. A method as in claim 1 wherein said image is placed by printing or optical image formation.

3. A method as in claim 2 wherein placement comprises embossing, casting or injection molding.

4. A method as in claim 2 wherein said printing comprises flexographic, offset, rotogravure, letter printing.

5. A method as in claim 2 wherein said optical image formation comprises formation of holographic, optical variable device, diffractive, dot-matrix, computer-generated holographic or computer-generated optical images.

6. A method as in claim 1 wherein said image on said web material is formed prior to metal coating by a flexographic, offset, rotogravure, letter press printing or holographic embossing process.

7. A method according to claim 1 further comprising adhering said demetallized web material to a second web material having discrete areas of images thereon using of adhesive between the materials, and thereafter adhesively transferring in registration said areas of images from said second web material to said demetallized web material by a cold foil stamping process.

8. A method according to claim 1 wherein said demetallization reveals designs or patterns hidden in the original images on the web.

9. A method as in claim 1 wherein said demetallization causes the appearance of a moiré pattern on the face of said web material.

10. A method as in claim 1 wherein said demetallization removes metal from an area adjacent to but not covering said image.

11. A method as in claim 1 wherein said web comprises a continuous roll of film or paper containing holographic, diffractive, optical variable images or patterns, optically computer-generated holograms, holographic or diffractive dot-matrix images or patterns, or non-holographic images or patterns.

12. A method as in claim 1 wherein said web material comprises film or paper.
